(19) United States
(12) Patent Application Publication
(10) Pub. No.: US 2003/0001865 A1
(43) Pub. Date: Jan. 2, 2003

(54) Information display device and method for displaying information

(75) Inventors: Yoshifumi Hirose, Kashihara (JP); Shinichi Yoshizawa, Neyagawa (JP)

Correspondence Address: MERCHANT & GOULD PC, P.O. BOX 2903, MINNEAPOLIS, MN, 55402-0903, US

(73) Assignee: Matsushita Electric Industrial Co., Ltd., Kadoma (JP)

(21) Appl. No.: 10/185,795

(22) Filed: Jun. 27, 2002

(30) Foreign Application Priority Data
Jun. 28, 2001 (JP) 2001-196909

(51) Int. Cl. G09G 5/00

(52) U.S. Cl. 345/619

(57) ABSTRACT

An information display device includes a display capable of displaying first information belonging to a first hierarchy and second information belonging to a second hierarchy, and an operation means capable of executing a first scrolling operation for scrolling the display on which the first information belonging to the first hierarchy is displayed, a second scrolling operation for scrolling the display on which the second information belonging to the second hierarchy is displayed, and a hierarchy switching operation for switching between the first information belonging to the first hierarchy and the second information belonging to the second hierarchy to be displayed. The first scrolling operation, the second scrolling operation and the hierarchy switching operation, which are executed by the operation means, are the same kind of operation.

### BACKGROUND OF THE INVENTION

1. Field of the Invention

The present invention relates to an information display device for displaying hierarchical information and a method for displaying the information.

2. Description of the Related Art

In general, since the size of a display screen for displaying information is limited, it is impossible to display all the detailed information. Therefore, in order to provide a user with a larger amount of information, in general, the information is organized into a sequential hierarchy from highly abstract information to detailed information, thereby displaying information efficiently.

Hitherto, in the case of displaying and retrieving such hierarchical information, a user carried out a two-stage operation including a stage of selecting the intended hierarchy and retrieving target information, and a stage of switching the hierarchy and retrieving information.

For example, in a system such as a car navigation system, which is capable of switching a map to be displayed, in the case of setting a destination distant from the present position, a user once displayed a wide-area map so as to set a rough position, then changed the wide-area map into a detailed map belonging to a hierarchy lower than the hierarchy to which the wide-area map belongs, and thereafter set the actual destination.

However, since the operation of switching the hierarchy and the operation of retrieving information were not continuous operations, it was necessary to carry out the operation of retrieving information after switching the hierarchy once, and then switching the hierarchy again. Thus, it took a long time for a user to obtain the desired information.

More specifically, in a car navigation system, when a user sets the destination, in the case where the destination is near the present position, it is possible to set the destination by scrolling a screen with the same scale map displayed on the screen. However, in the case where the destination is distant from the present position, it takes a long time to scroll the screen until the destination appears with the detailed map displayed on the screen. Therefore, the user switched the scale of the map by using a switch for changing the scale of the map so as to display the wide-area map and set the destination roughly, and then switched the scale again so as to display the detailed map and set the actual destination.

In the latter case, in order to determine the destination, the operation by using the switch for changing the hierarchy i.e., the scale of the map) has to be carried out at least twice, and each of the switching operation of the hierarchy and the operation of scrolling the screen is a separate operation. Therefore, there is a problem in that it takes an extremely long time to carry out these operations.

In order to solve this problem, JP 2000-292194 A discloses that the switching of the hierarchy is carried out by pressing a scrolling button for a predetermined time so as to make the scrolling operation be continuous to a screen expanding operation or a screen reducing operation. However, in order to switch the hierarchy, since a user has to keep pressing the scrolling button for a predetermined time, it takes a long time to switch the hierarchy. Thus, there is a problem that the hierarchy cannot be switched for an instant.

Furthermore, in an EPG (Electronic Program Guide), a time period, a title, casts of characters, contents etc. of a program were displayed on the display unit. However, since the screen size of the display unit is limited, the amount of information that can be displayed at one time was limited. Therefore, when a user wishes to read program information to be broadcasted in the time period distant from the time period when currently displayed program information is broadcasted, it is necessary to scroll the screen sequentially. Thus, it takes a long time.

Furthermore, in a memory dial system for retrieving a telephone number from a name or designation of an owner of a telephone, a user retrieves a telephone number by sequentially scrolling names or designations in alphabetical order, or retrieves by selecting “the initial letter of names or designations” by a switch for selecting “the initial letter (e.g. “A,” “B,” etc.) of name or designation” and then scrolling through names or designations in alphabetical order. There is a problem that this way of retrieving is time consuming because the operation of selecting “the initial letter of names or designations” and the operation of scrolling the name or designation are separate operations.

With the foregoing in mind, it is therefore an object of the present invention to provide a hierarchical information display device capable of easily and rapidly displaying target information required by a user from the hierarchical information and to provide a method for displaying hierarchical information.

### SUMMARY OF THE INVENTION

The information display device of the present invention includes a display capable of displaying at least first information belonging to a first hierarchy and second information belonging to a second hierarchy, and an operation means capable of executing a first scrolling operation for scrolling the display on which the first information belonging to the first hierarchy is displayed, a second scrolling operation for scrolling the display on which the second information belonging to the second hierarchy is displayed, and a hierarchy switching operation for switching between the first information belonging to the first hierarchy and the second information belonging to the second hierarchy to be displayed; wherein the first scrolling operation, the second scrolling operation and the hierarchy switching operation, which are executed by the operation means, are the same kind of operation.

In this specification, the same kind of operation means an operation belonging to the same concept. For example, the operation of inclining the stick is an operation of the concept for moving a stick and the operation of pushing the stick along the axis direction of the stick is also an operation of the concept of moving the stick. Thus, the operation of inclining the stick and the operation of pushing the stick along the axis direction of the stick are common in that both operations are the operation of moving the stick. Therefore, the operation of inclining the stick and the operation of pushing the stick along the axis direction are the same kind of operation.

Furthermore, the scrolling operation herein denotes an operation of moving data displayed on the screen of the display device up/down or right/left, so that new data following the existing data appear on the screen.

The method for displaying information of the present invention includes displaying at least a first information belonging to a first hierarchy on the display, executing a first scrolling operation for scrolling the display on which the first information belonging to the first hierarchy is displayed, executing a hierarchy switching operation for switching the first information belonging to the first hierarchy to a second information belonging to a second hierarchy to be displayed on the display, and executing a second scrolling operation for scrolling the display on which the second information belonging to the second hierarchy is displayed, wherein the first scrolling operation, the second scrolling operation and the hierarchy switching operation are the same kind of operation.

### BRIEF DESCRIPTION OF THE DRAWINGS

FIG. 1 is a block diagram showing an information display device according to a first embodiment of the present invention.

FIG. 2 is a view to illustrate a map database for a car navigation system stored in a database provided in the information display device according the first embodiment.

FIG. 3 is a front view schematically showing an operation unit provided in the information display device according to the first embodiment.

FIG. 4 is a view to illustrate the map database for a car navigation system displayed on the display unit provided in the information display device according the first embodiment.

FIG. 5 is a block diagram showing another information display device according to the first embodiment of the present invention.

FIG. 6 is a front view schematically showing another operation unit provided in another information display device according to the first embodiment.

FIG. 7 is a block diagram showing a further information display device according to a first embodiment of the present invention.

FIG. 8A is a cross-sectional view schematically showing a further operation unit and a position detection switch provided in the further information display device according to the first embodiment; and FIG. 8B is a plan view schematically showing a further operation unit.

FIG. 9 is a block diagram showing yet a further information display device according to a first embodiment of the present invention.

FIG. 10 is a cross-sectional view schematically showing yet a further operation unit and a position detection switch provided in the yet further information display device according to the first embodiment.

FIG. 11 is a block diagram showing an information display device according to a second embodiment of the present invention.

FIG. 12 is a view to illustrate program information in an EPG stored in a database provided in an information display device according to the second embodiment.

FIG. 13 is a view to illustrate program information in an EPG displayed on the display unit provided in the information display device according to the second embodiment.

FIG. 14 is a block diagram showing an information display device according to a third embodiment of the present invention.

FIG. 15 is a view to illustrate memory dial information stored in a database provided in the information display device according to the third embodiment

FIG. 16 is a view to illustrate memory dial information to be displayed on a display unit provided in the information display device according to the third embodiment.

### DETAILED DESCRIPTION OF THE INVENTION

According to the information display device of the present invention, a first scrolling operation for scrolling the display on which the first information belonging to the first hierarchy is displayed, a second scrolling operation for scrolling the display on which the second information belonging to the second hierarchy is displayed, and a hierarchy switching operation for switching between the first information belonging to the first hierarchy and the second information belonging to the second hierarchy to be displayed are the same kind of operation. Thus, target information required by a user can be displayed from the hierarchical information easily and rapidly.

It is preferable that the operation means includes a base and a stick provided swingably on the base, and that the same kind of operation is an operation of inclining the stick. It is advantageous because it is possible to display the target information from the hierarchical information by only the operation of inclining the stick.

It is preferable that the first scrolling operation is an operation of inclining the stick at a tilt angle that is smaller than a predetermined tilt angle relative to the direction perpendicular to the base, the second scrolling operation is an operation of inclining the stick at a tilt angle that is not smaller than the predetermined tilt angle, and the hierarchy switching operation is an operation of inclining the stick in the direction across the direction expressed by the predetermined tilt angle. Furthermore, it is preferable that the display displays the first information belonging to the first hierarchy while the tilt angle of the stick relative to the direction perpendicular to the base is smaller than the predetermined tilt angle, and displays the second information belonging to the second hierarchy while the tilt angle of the stick is not smaller than the predetermined tilt angle. It is advantageous because all of the first and second scrolling operations and the hierarchy switching operation are operation of inclining the stick, so that it is possible to display the target information from the hierarchical information easily and rapidly.

It is preferable that the information display device further includes an angle sensor for detecting the tilt angle of the stick relative to the direction perpendicular to the base, and a hierarchy selection means for selecting any one of the first hierarchy and the second hierarchy based on the tilt angle of the stick detected by the angle sensor, and that the display displays the first information belonging to the first hierarchy while the hierarchy selection means selects the first hierarchy, and displays the second information belonging to the second hierarchy while the hierarchy selection means selects the second hierarchy. It is advantageous because it is possible to display the target information from the hierarchical information easily and rapidly with a simple configuration.

It is preferable that the operation means includes a base and a dial member provided rotatably on the base, and the same kind of the operation is an operation of rotating the dial member. It is advantageous because it is possible to display the target information from the hierarchical information only by the operation of rotating the dial member.

It is preferable that the first scrolling operation and the second scrolling operation are operations of rotating the dial member at a rotation speed that is lower than a predetermined rotation speed, and the hierarchy switching operation is an operation of rotating the dial member at a rotation speed that is not lower than the predetermined rotation speed. It is advantageous because all of the first and second scrolling operations and the hierarchy switching operation can be carried out by rotating the dial member.

It is preferable that the information display device includes a rotation speed sensor for detecting the rotation speed of the dial member, and a hierarchy switching means for switching between the first hierarchy and the second hierarchy based on the rotation speed of the dial member detected by the rotation speed sensor, and that the display switches between the first information belonging to the first hierarchy and the second information belonging to the second hierarchy to be displaced, in accordance with the switching between the first hierarchy and the second hierarchy by the hierarchy switching means. It is advantageous because it is possible to display the target information from the hierarchical information easily and rapidly with a simple configuration.

It is preferable that the operation means includes a base and a stick provided swingably on the base, and the same kind of operation is an operation of moving the stick. It is advantageous because it is possible to display the target information from the hierarchical information only by the operation of moving the stick.

It is preferable that the first scrolling operation and the second scrolling operation are operations of inclining the stick, and the hierarchy switching operation is an operation of moving the stick along the axis direction of the stick. It is advantageous because all of the first and second scrolling operations and the hierarchy switching operation can be carried out by moving the stick.

It is preferable that the hierarchy switching operation is an operation of pushing the stick into the base along the axis direction of the stick. Furthermore, it is preferable that the hierarchy switching operation is an operation of pulling back the stick from the base along the axis direction of the stick. It is advantageous because the hierarchy switching operation can be carried out by moving the stick.

It is preferable that the information display device further includes a position detection means for detecting the position along the axis direction of the stick, and a hierarchy selection means for selecting any one of the first hierarchy and the second hierarchy based on the position along the axis direction of the stick detected by the position detection means, and that the display displays the first information belonging to the first hierarchy while the hierarchy selection means selects the first hierarchy, and displays the second information belonging to the second hierarchy while the hierarchy selection means selects the second hierarchy. It is advantageous because it is possible to display the target information from the hierarchical information easily and rapidly with a simple configuration.

It is preferable that the operation means includes a base and a dial member provided rotatably on the base, and the same kind of operation is an operation for moving the dial member. It is advantageous because it is possible to display the target information from the hierarchical information by only the operation of moving the dial member.

It is preferable that the first scrolling operation and the second scrolling operation are operations of rotating the dial member, and the hierarchy switching operation is an operation of moving the dial member along the direction perpendicular to the rotation axis of the dial member. It is advantageous because all of the first and second scrolling operations and the hierarchy switching operation can be carried out by moving the dial member.

It is preferable that the hierarchy switching operation is an operation for pushing the dial member into the base along the direction perpendicular to the rotation axis of the dial member. It is preferable that the hierarchy switching operation is an operation for pulling back the dial member from the base along the direction perpendicular to the rotation axis of the dial member. It is advantageous because the hierarchy switching operation can be carried out by moving the dial member.

It is preferable that the information display device further includes a position detection means for detecting the position along the direction perpendicular to the rotation axis of the dial member, and a hierarchy selection means for selecting any of the first hierarchy and the second hierarchy based on the position along the direction perpendicular to the rotation axis of the dial member detected by the position detection means, and that the display displays the first information belonging to the first hierarchy while the hierarchy selection means selects the first hierarchy, and displays the second information belonging to the second hierarchy while the hierarchy selection means selects the second hierarchy. It is advantageous because it is possible to display the target information from the hierarchical information easily and rapidly with a simple configuration.

It is preferable that the second information belonging to the second hierarchy is information of broader concept with respect to the first information belonging to the first hierarchy. It is advantageous because it is possible to switch between information of the broader concept and information of the narrower concept easily and rapidly.

It is preferable that the first information belonging to the first hierarchy and the second information belonging to the second hierarchy are information representing a map. Furthermore, it is preferable that the first information belonging to the first hierarchy is information representing a detailed map, and the second information belonging to the second hierarchy is information representing a wide-area map. It is advantageously applicable to a car navigation system for driving a car.

It is preferable that the first information belonging to the first hierarchy and the second information belonging to the second hierarchy are program information in an Electronic Program Guide (EPG). It is advantageously applicable to an EPG system.

It is preferable that the first information belonging to the first hierarchy and the second information belonging to the second hierarchy are information relating to a memory dial. It is advantageously applicable to retrieving a telephone number in memory dial information used for a mobile telephone.

Hereinafter, the embodiment of the present invention will be explained with reference to the drawings.

(First Embodiment)

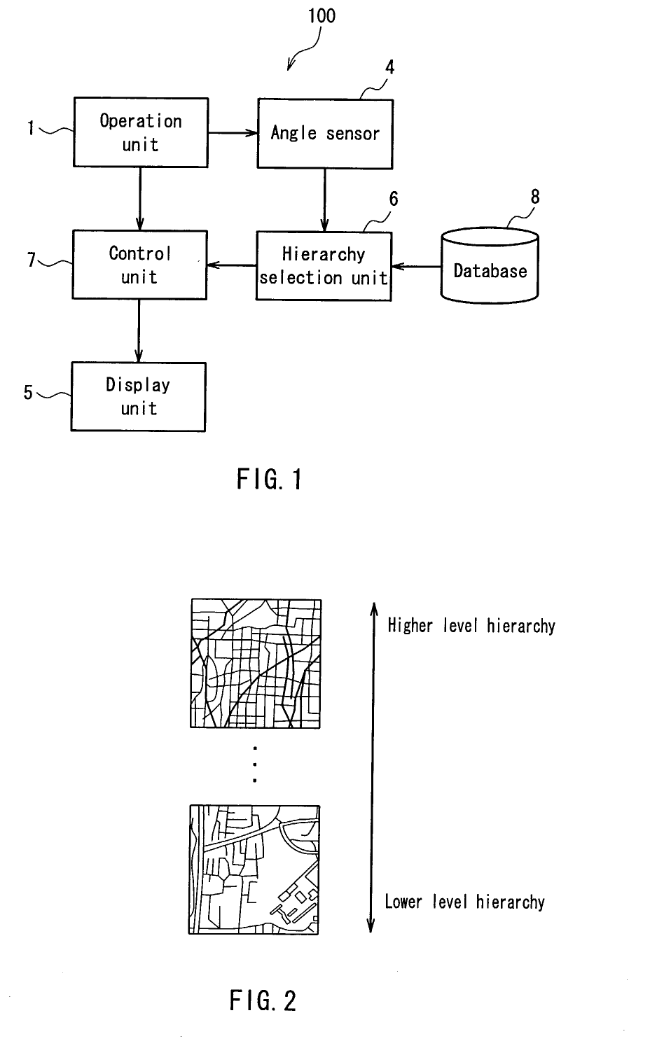

FIG. 1 is a block diagram showing an information display device 100 according to a first embodiment. The information display device 100 according to the first embodiment can display a map in a car navigation system. The information display device 100 includes a database 8. The database 8 holds hierarchical information.

FIG. 2 is a view to illustrate a map database for a car navigation system stored in the database 8. The map database stored in the database 8 is hierarchized into a wide-area map belonging to a higher level hierarchy and a detailed map belonging to a lower level hierarchy.

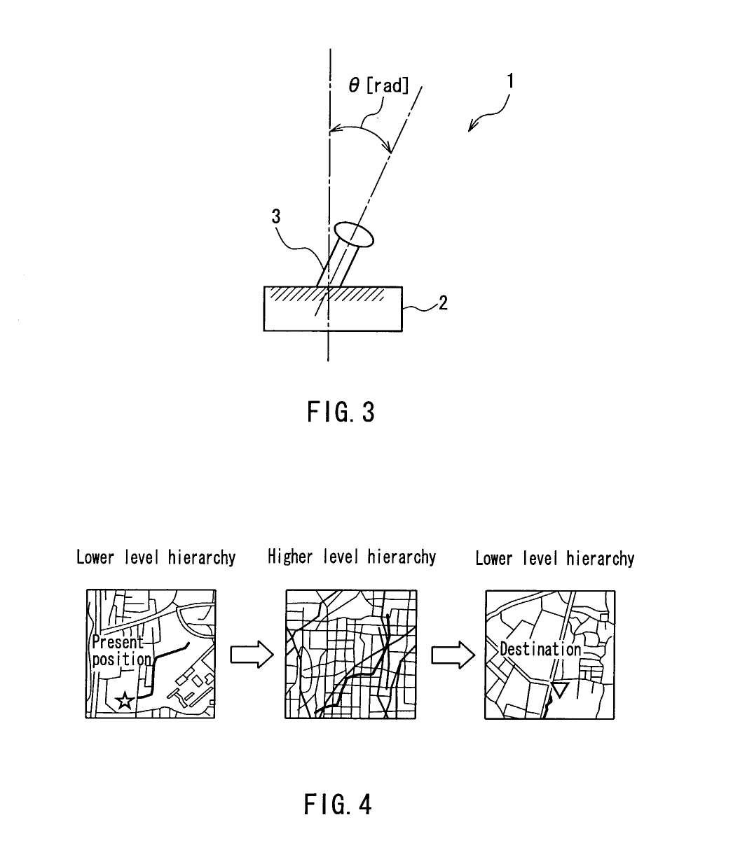

FIG. 3 is a front view schematically showing an operation unit 1 provided in the information display device 100. The operation unit 1 includes a base 2 having a substantially rectangular parallelepiped shape and a stick 3 provided on the base 2 swingably with one end thereof as a center.

The information display device 100 is provided with an angle sensor 4. The angle sensor 4 detects a tilt angle θ [radian] of the stick 3 relative to the direction perpendicular to the surface of the base 2.

The information display device 100 includes a hierarchy selection unit 6. The hierarchy selection unit 6 selects the detailed map belonging to the lower level hierarchy from the map database stored in the database 8 while the tilt angle θ [radian] of the stick 3 detected by the angle sensor 4 is smaller than a predetermined tilt angle, for example, π/4 [radian]; and selects the wide-area map belonging to the higher level hierarchy from the map database stored in the database 8 while the tilt angle θ of the stick 3 detected by the angle sensor 4 is not smaller than the predetermined tilt angle, for example, π/4 [radian]. Then, the selected maps are output to a control unit 7.

The control unit 7 displays the detailed map belonging to the lower level hierarchy on a display unit 5 while the detailed map belonging to the lower level hierarchy is selected by the hierarchy selection unit 6, and displays the wide-area map belonging to the higher level hierarchy on the display unit 5 while the wide-area map belonging to the higher level hierarchy is selected.

Thus, the detailed map belonging to the lower level hierarchy is displayed on the displaying unit 5 while the tilt angle θ of the stick 3 is smaller than a predetermined tilt angle, and the wide-area map belonging to the higher level hierarchy is displayed on the displaying unit 5 while the tilt angle θ is not smaller than the predetermined tilt angle.

When the stick 3 is inclined forward/backward and right/left at a tilt angle θ of the stick 3 in the range of being smaller than the predetermined tilt angle in a state in which the detailed map belonging to the lower level hierarchy is displayed on the display unit 5, the control unit 7, in accordance with the inclining of the stick 3, moves the cursor vertically and horizontally on the detailed map displayed on the display unit 5, or scrolls the detailed map displayed on the display unit 5 vertically and horizontally. For example, when the stick 3 is inclined toward the front of an operator, the cursor moves downwardly on the detailed map displayed on the display unit 5, or the detailed map displayed on the display unit 5 scrolls downwardly. When the stick 3 is inclined in the opposite direction, the cursor moves upwardly on the detailed map, or the detailed map displayed on the display unit 5 scrolls upwardly.

When the stick 3 is inclined forward/backward and right/left at a tilt angle 0 of the stick 3 in the range that is not smaller than the predetermined tilt angle in a state in which the wide-area map belonging to the higher level hierarchy is displayed on the display unit 5, the control unit 7, in accordance with the inclining of the stick 3, moves the cursor vertically and horizontally on the wide-area map displayed on the display unit 5, or scrolls the wide-area map displayed on the display unit 5 vertically and horizontally.

The following is an explanation of the operation of the information display unit 100 having the above-mentioned configuration. FIG. 4 is a view to illustrate a map database for a car navigation system to be displayed on the display unit 5 provided in the information display device 100. FIG. 4 shows examples of screens to be displayed before the driving destination is set.

First, the stick 3 is assumed to tilt at a tilt angle smaller than a predetermined tilt angle. The angle sensor 4 detects the tilt angle of the stick 3. The hierarchy selection unit 6 selects a detailed map belonging to the lower level hierarchy stored in the database 8 because the tilt angle detected by the angle sensor 4 is smaller than the predetermined tilt angle. The control unit 7 displays the detailed map belonging to the lower level hierarchy selected by the hierarchy selection unit 6 on the display unit 5. Thus, in the initial state, the detailed map belonging to the lower level hierarchy is displayed on the display unit 5.

When the stick 3 is inclined forward/backward and right/left at a tilt angle that is smaller than a predetermined tilt angle, the control unit 7, in accordance with the inclining of the stick 3, moves the cursor vertically and horizontally on the detailed map displayed on the display unit 5, or scrolls the detailed map displayed on the display unit 5 vertically and horizontally.

When the stick 3 is inclined in the direction across the direction expressed by the predetermined tilt angle from the tilt angle that is smaller than the predetermined tilt angle to the tilt angle that is not smaller than a predetermined tilt angle, the angle sensor 4 detects the tilt angle that is not smaller than the predetermined tilt angle as the tilt angle of the stick 3. Then, the hierarchy selection unit 6, which selected the detailed map belonging to the lower level hierarchy stored in the database 8, selects a wide-area map belonging to the higher level hierarchy because the tilt angle detected by the angle sensor 4 is not smaller than the predetermined tilt angle. Thereafter, the control unit 7 displays the wide-area map belonging to the higher level hierarchy selected by the hierarchy selection unit 6 on the display unit 5. Next, when the stick 3 is inclined forward/backward and right/left at the tilt angle that is a not smaller than the predetermined tilt angle, the control unit 7, in accordance with the inclining of the stick 3, moves the cursor vertically and horizontally on the wide-area map displayed on the display unit 5, or scrolls the wide-area map displayed on the display unit 5 vertically and horizontally.

When the stick 3 is inclined in the direction across the direction expressed by the predetermined tilt angle from the tilt angle that is not smaller than the predetermined tilt angle to the tilt angle that is smaller than the predetermined tilt angle, the angle sensor detects the tilt angle that is smaller than the predetermined tilt angle as the tilt angle of the stick 3. Thereafter, the hierarchy selection unit 6, which selected the wide-area map belonging to the higher level hierarchy stored in the database 8, selects a detailed map corresponding to the position of the cursor on the wide-area map because the tilt angle detected by the angle sensor 4 is smaller than the predetermined tilt angle. Next, the control unit 7 displays the detailed map belonging to the lower level hierarchy selected by the hierarchy selection unit 6 on the display unit 5. When the stick 3 is inclined forward/backward and right/left at the tilt angle that is smaller than the predetermined tilt angle, the control unit 7, in accordance with the inclining of the stick 3, moves the cursor on the detailed map displayed on the display unit 5 vertically and horizontally, or scrolls the detailed map displayed on the display unit 5 vertically and horizontally.

Thus, when the intended destination is distant from the present position indicated by the cursor on the detailed map, so that the destination is not shown on the screen and the long time scrolling operation is required until the destination appears on the screen, by inclining the stick 3 in the direction across the direction expressed by the predetermined tilt angle from the tilt angle smaller than the predetermined tilt angle to the tilt angle that is not smaller than the predetermined tilt angle, the wide-area map is displayed and then the cursor is moved in a state in which the wide-area map is displayed. When the cursor is moved to the rough destination on the wide-area map, by inclining the stick 3 in the direction across the direction expressed by the predetermined tilt angle from the tilt angle that is not smaller than the predetermined tilt angle to the tilt angle that is smaller than the predetermined tilt angle, the detailed map is displayed again and the cursor is moved to the exact destination in a state in which the detailed map is displayed. In this way, only while the tilt angle of the stick 3 is a not smaller than the predetermined tilt angle, the wide-area map is displayed and the destination is set. Therefore, a first scrolling operation for inclining the stick 3 at the tilt angle that is smaller than the predetermined tilt angle for scrolling the display unit 5 on which the detailed map belonging to the lower level hierarchy is displayed, a second scrolling operation for inclining the stick 3 at the tilt angle that is not smaller than the predetermined tilt angle for scrolling the display unit 5 on which the wide-area map belonging to the higher level hierarchy is displayed, and a hierarchy switching operation for inclining the stick in the direction across the direction expressed by the predetermined tilt angle for switching between the detailed map belonging to the lower level hierarchy and the wide-area map belonging to the higher level hierarchy to be displayed are the same kind of operation, that is, an operation of inclining the stick 3.

As mentioned above, according to the first embodiment, the information display device includes the display device 5 capable of displaying the detailed map belonging to the lower level hierarchy and the wide-area map belonging to the higher level hierarchy, and the operation unit 1 capable of executing a first scrolling operation for scrolling the display unit 5 on which the detailed map belonging to the lower level hierarchy is displayed, a second scrolling operation for scrolling the display unit 5 on which the wide-area map belonging to the higher level hierarchy is displayed, and a hierarchy switching operation for switching between the detailed map belonging to the lower level hierarchy and the wide-area map belonging to the higher level hierarchy to be displayed. The first scrolling operation, the second scrolling operation and the hierarchy switching operation, which are executed by the operation unit 1, are the same kind of operation. Therefore, it is possible to allow information indicating the destination at which a user aims to be displayed from the hierarchical map information easily and rapidly.

Note here that two kinds or more of predetermined tilt angles are provided, and thereby map information belonging to three kinds or more of the hierarchies may be displayed. Furthermore, the information display device may be operated by a program storage medium storing a computer program of the above-mentioned method for displaying information.

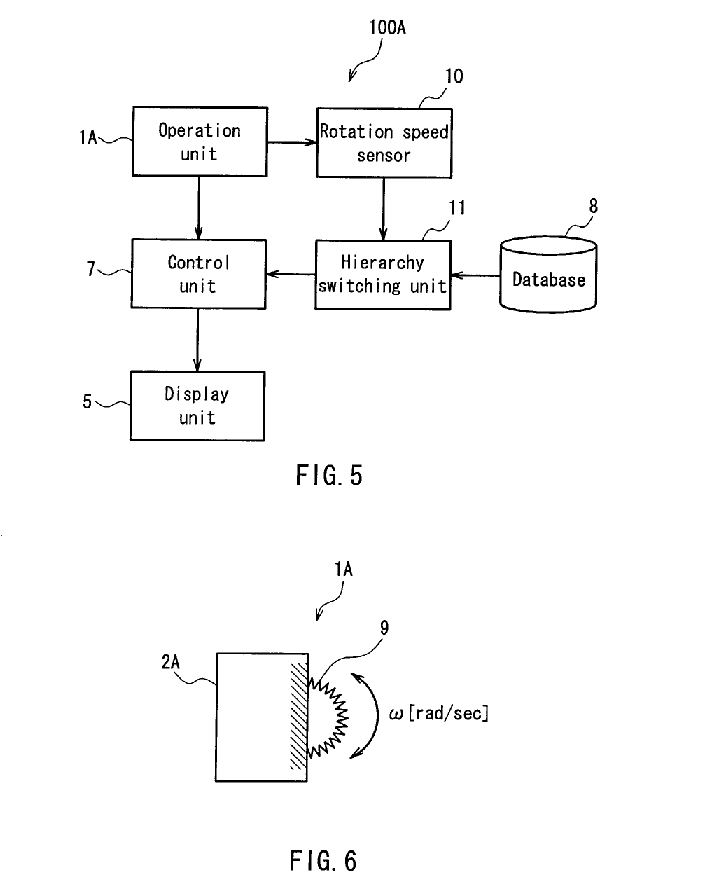

FIG. 5 is a block diagram showing another information display device 100A according to a first embodiment; and FIG. 6 is a front view schematically showing another operation unit 1A provided in another information display device 100A. The same component elements as in the above-mentioned information display device 100 explained with reference to FIGS. 1 and 3 are given the same reference numerals are given and therefore the detailed explanation thereof is omitted herein.

The difference from the above-mentioned information display device 100 is in that the operation unit 1A is provided instead of the operation unit 1; a rotation speed sensor 10 is provided instead of the angle sensor 4; and a hierarchy switching unit 11 is provided instead of the hierarchy selection unit 6. The operation unit 1A includes a base 2A having a substantially rectangular parallelepiped shape and a dial member 9 provided rotatably on the base 2A. The rotation speed sensor 10 detects the rotation speed of the dial member 9. The hierarchy switching unit 11 switches between a higher level hierarchy and a lower level hierarchy when the rotation speed co of the dial member 9 detected by the rotation speed sensor 10 is not lower than a predetermined rotation speed. The control unit 7 switches between a wide-area map belonging to the higher level hierarchy and a detailed map belonging to lower level hierarchy to be displayed on the display unit 5 in accordance with the switching between the higher level hierarchy and lower level hierarchy by the hierarchy switching unit 11.

The following is an explanation of the operation of the information display unit 100A having the above-mentioned configuration. First, in the initial state, a detailed map belonging to the lower level hierarchy is assumed to be displayed on the display unit 5.

When the dial member 9 is rotated at a speed that is lower than the predetermined rotation speed, the control unit 7, in accordance with the rotation of the dial member 9, moves the cursor on the detailed map displayed on the display unit 5, or scrolls the detailed map displayed on the display unit.

Then, when the dial member 9 is rotated at a speed not lower than the predetermined speed, the rotation speed sensor 10 detects the rotation speed that is not lower than the predetermined speed as the rotation speed of the dial member 9. Next, the hierarchy switching unit 11 switches the detailed map belonging to the lower level hierarchy into the wide-area map belonging to the higher level hierarchy because the rotation speed detected by the rotation speed sensor 10 is not lower than a rotation speed. Thereafter, the control unit 7 displays the wide-area map belonging to the higher level hierarchy, which was switched by the hierarchy switching unit 11, on the display unit 5. Then, when the dial member 9 is rotated at a rotation speed that is lower than the predetermined rotation speed, the control unit 7, in accordance with the rotation of the dial member 9, moves the cursor in the wide-area map displayed on the display unit 5, or scrolls the wide-area map displayed on the display unit 5.

Thereafter, when the dial member 9 is rotated at a rotation speed that is not lower than a predetermined rotation speed again, the rotation speed sensor 10 detects the rotation speed that is not lower than a predetermined rotation speed as a rotation speed of the dial member 9. The hierarchy switching unit 11 switches the wide-area map belonging to the higher level hierarchy into the detailed map belonging to the lower level hierarchy because the detected rotation speed detected by the rotation speed sensor 10 is not lower than a predetermined rotation speed. Next, the control unit 7 displays the detailed map belonging to the lower level hierarchy that is switched by the hierarchy switching unit 11 on the display unit 5. When the dial member 9 is rotated at the rotation speed that is smaller than a predetermined speed, the control unit 7, in accordance with the rotation of the dial member 9, moves the cursor on the detailed map displayed on the display unit 5 or the scrolls the detailed map.

Instead of the above, the information display device 100A may be operated as follows. When the dial member 9 is rotated at a rotation speed that is lower than the predetermined rotation speed, the control unit 7, in accordance with the rotation of the dial member 9, moves the cursor in the detailed map displayed on the display unit 5 or scrolls the detailed map displayed on the display unit 5.

Then, when the dial member 9 is rotated at a speed not lower than a predetermined rotation speed, the rotation speed sensor 10 detects the rotation speed that is not lower than the predetermined rotation speed as the rotation speed of the dial member 9. Next, the hierarchy switching unit 11 switches the detailed map belonging to the lower level hierarchy into the wide-area map belonging to the higher level hierarchy because the rotation speed detected by the rotation speed sensor 10 is not lower than a predetermined rotation speed. Thereafter, the control unit 7 displays the wide-area map belonging to the higher level hierarchy, which was switched by the hierarchy switching unit 11, on the display unit 5. Then, when the dial member 9 is rotated at a rotation speed that is higher than the predetermined rotation speed, the control unit 7, in accordance with the rotation of the dial member 9, moves the cursor in the wide-area map displayed on the display unit 5 or scrolls the wide-area map displayed on the display unit 5.

Namely, if the dial member 9 is rotated at high speed, for example, along the clockwise direction, the wide-area map is displayed on the display unit 5 and the cursor moves upwardly or the wide-area map scrolls upwardly. If the dial member 9 is rotated at high speed, for example, along a counterclockwise direction, the wide-area map is displayed on the display unit 5 and the cursor moves downwardly or the wide-area map scrolls downwardly.

Then, when the dial member 9 is rotated at a speed not higher than the predetermined rotation speed, the rotation speed sensor 10 detects the rotation speed that is not higher than the predetermined rotation speed as the rotation speed of the dial member 9. The hierarchy switching unit 11 switches the wide-area map belonging to the higher level hierarchy into the detailed map belonging to the lower level hierarchy because the rotation speed detected by the rotation speed sensor 10 is not higher than a predetermined rotation speed. Next, the control unit 7 displays the detailed map belonging to the lower level hierarchy, which was switched by the hierarchy switching unit 11, on the display unit 5. Then, when the dial member 9 is rotated at a rotation speed that is lower than the predetermined rotation speed, the control unit 7, in accordance with the rotation of the dial member 9, moves the cursor in the detailed map displayed on the display unit 5 or scrolls the detailed map displayed on the display unit 5.

Namely, if the dial member 9 is rotated at low speed along a clockwise direction, the detailed map is displayed on the display unit 5 and the cursor moves upwardly or the detailed map scrolls upwardly. For example, if the dial member 9 is rotated at low speed along a counterclockwise direction, the detailed map is displayed on the display unit 5 and the cursor moves downwardly or the detailed map scrolls downwardly.

Thus, the first scrolling operation of rotating the dial member 9 at the rotation speed that is lower than a predetermined rotation speed to scroll the display unit 5 on which the detailed map belonging to the lower level hierarchy is displayed, the second scrolling operation of rotating the dial member 9 at the rotation speed that is lower than the predetermined rotation speed to scroll the display unit 5 on which the wide-area map belonging to the higher level hierarchy is displayed, and the hierarchy switching operation of rotating the dial member 9 at the rotation speed not lower than the predetermined rotation speed for switching the detailed map belonging to the lower level hierarchy and the wide-area map belonging to the higher level hierarchy to be displayed are the same kind of operation of rotating the dial member 9. Thus, it is possible to display information including the intended destination from the hierarchical map information easily and rapidly.

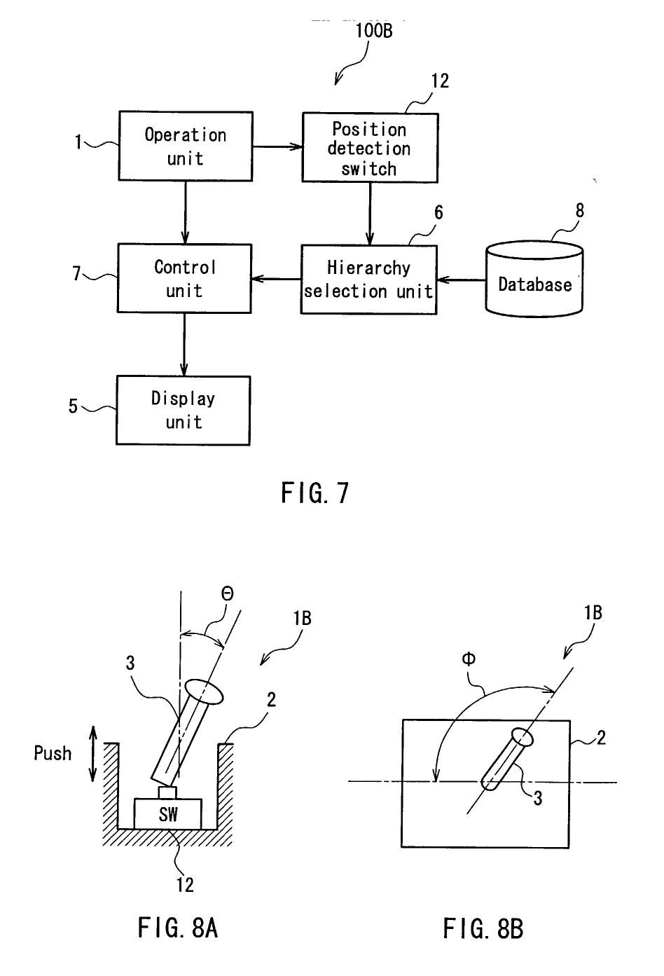

FIG. 7 is a block diagram showing a further information display device 100B according to the first embodiment. FIG. 8A is a cross-sectional view schematically showing a further operation unit 1B and a position detection switch 12 provided in a further information display device 100B; and FIG. 8B is a plan view schematically showing a further operation unit 1B. The same component elements as in the above-mentioned information display device 100 explained with reference to FIGS. 1 and 3 are given the same reference numerals and therefore the explanation thereof is omitted herein.

The difference from the above-mentioned information display device 100 is in that the operation unit 1B is provided instead of the operation unit 1, and a position detection switch 12 is provided instead of the angle sensor 4. The operation unit 1B includes a base 2 having a substantially rectangular parallelepiped shape and a stick 3 provided on the base 2 swingably with one end as a center. The base 2 is provided with the position detection switch 12 for detecting the position of one end of the stick 3.

In accordance with the tilt angle Θ of the stick 3 relative to the direction perpendicular to the surface of the base 2 and the angle Φ indicating the tilting direction of the stick 3, the control unit 7 moves the cursor on the display device 5. The direction in which the cursor moves is designated by the tilt angle Φ indicating the tilting direction of the stick 3. The speed at which the cursor moves is designated by the tilt angle Θ of the stick 3. For example, when the tilt angle Φ=0 is satisfied, showing that the stick 3 stands straight, the cursor stops. As the tilt angle Θ is increased and approaches π/2 [radian], the moving speed of the cursor is increased.

The stick 3 is movable along the axis direction thereof. At one end of the stick 3, an elastic body (not shown in the drawings) is provided. In this configuration, if the stick 3 is pushed along the axis direction thereof, an elastic body (not shown in the drawings) provided at one end of the stick 3 presses the position detection switch 12, and thereby the position detection switch 12 is turned on; and if the stick 3 is pulled back along the axis direction thereof, an elastic body (not shown in the drawings) provided at one end of the stick 3 is apart from the position detection switch 12, and thereby the position detection switch 12 is turned off.

The following is an explanation of the operation of the information display unit 100B having the above-mentioned configuration. First, the elastic body provided at one end of the stick 3 is assumed to be apart from the position detection switch 12 and the switch is assumed to be in the off position.

The hierarchy selection unit 6 selects the lower level hierarchy while the position detection switch 12 is in the off position. The control unit 7 displays the detailed map belonging to the lower level hierarchy selected by the hierarchy selection unit 6 on the display unit 5. When the stick 3 is inclined forward/backward and right/left in a state in which the elastic body provided at one end of the stick 3 is apart from the position detection switch 12, the control unit 7, in accordance with the inclining of the stick 3, moves the cursor vertically and horizontally on the detailed map displayed on the display unit 5, or scrolls vertically and horizontally the detailed map displayed on the display unit 5.

As a result of the stick 3 being pushed along the axis direction of the stick 3, when the elastic body provided on one end of the stick 3 presses the position detection switch 12 and thereby the position detection switch 12 is turned on, the hierarchy selection unit 6, which selected the lower level hierarchy, selects the higher level hierarchy. The control unit 7 displays the wide-area map belonging to the higher level hierarchy selected by the hierarchy selection unit 6 on the display unit 5.

When the stick 3 is inclined forward/backward and right/left in a state in which the elastic body provided at one end of the stick 3 presses the position detection switch 12 and the position detection switch 12 is in the on position, the control unit 7, in accordance with the inclining of the stick 3, moves the cursor vertically and horizontally on the wide-area map displayed on the display unit 5, or scrolls vertically and horizontally the wide-area map displayed on the display unit 5.

When the stick 3 is pulled back along the axis direction of the stick 3, the elastic body provided at one end of the stick 3 is apart from the position detection switch 12, and thereby the position detection switch 12 is turned off. When the position detection switch 12 is off, the hierarchy selection unit 6 selects the lower level hierarchy. The control unit 7 displays the detailed map belonging to the lower level hierarchy selected by the hierarchy selection unit 6 on the display unit 5.

Thus, when the stick 3 is inclined forward/backward and right/left in a state in which the elastic body provided at one end of the stick 3 is apart from the position detection switch 12 and thereby the position detection switch 12 is in the off position, the control unit 7, in accordance with the inclining of the stick 3, moves the cursor vertically and horizontally on the detailed map displayed on the display unit 5, or scrolls vertically and horizontally the detailed map displayed on the display unit 5.

Thus, the first scrolling operation of inclining the stick 3 for scrolling the display unit 5 on which the detailed map belonging to the lower level hierarchy is displayed in a state in which the position detection switch 12 is in the off position, the second scrolling operation of inclining the stick 3 for scrolling the display unit 5 on which the wide-area map belonging to the higher hierarchy is displayed in a state in which the position detection switch 12 is in the on position, and the hierarchy switching operation of pushing or pulling back the stick 3 along the axis direction of the stick 3 for switching between the detailed map belonging to the lower level hierarchy and the wide-area map belonging to the higher level hierarchy to be displayed are the same kind of operation of moving the stick 3. Thus, it is possible to display information including the intended destination from the hierarchical map information easily and rapidly.

Note here that the case where the hierarchy selection unit 6 selects the higher level hierarchy when the stick 3 is pushed and the position detection switch 12 is turned on is described. However, the present invention is not necessarily limited to this. The hierarchy selection unit 6 may select the lower level hierarchy when the position detection switch 12 is turned on and may select the higher level hierarchy when the position detection switch 12 is turned off.

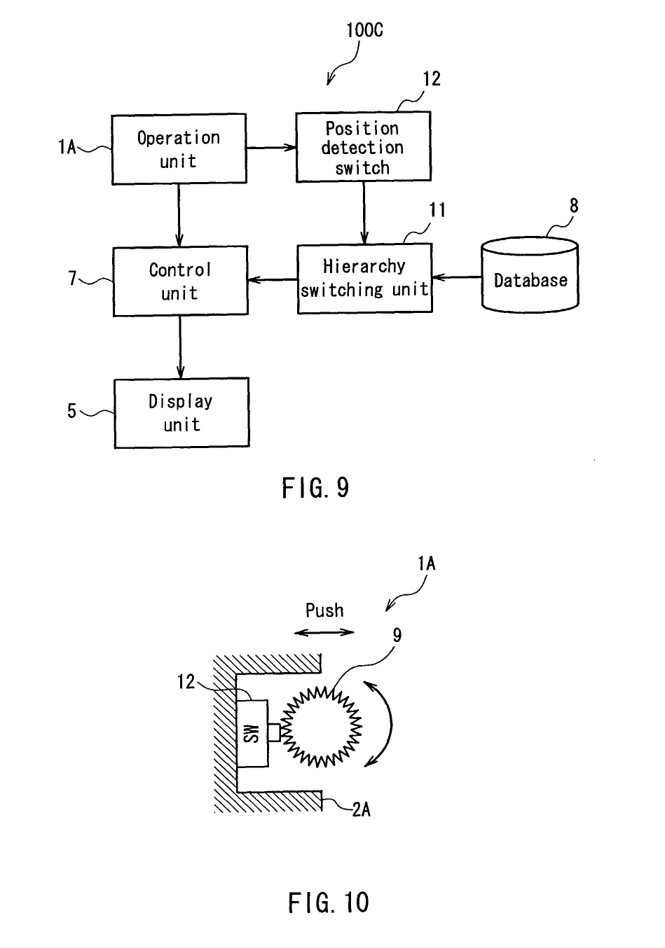

FIG. 9 is a block diagram showing a further information display device 100C according to a first embodiment; and FIG. 10 is a cross-sectional view schematically showing a further operation unit 1A and a position detection switch 12 provided in the further information display device 100C. The same component elements as in the above-mentioned information display device 100A explained with reference to FIGS. 5 and 6 are given the same reference numerals and therefore the explanation thereof is omitted herein. The difference from the above-mentioned information display device 100A is in that the position detection switch 12 mentioned above relating to the information display device 100B is provided instead of the rotation speed sensor 10.

The operation unit 1A includes a base 2A having a substantially rectangular parallelepiped shape and a dial member 9 provided rotatably on the base 2A. The dial member 9 is movable along the direction perpendicular to the surface of the base 2A. The base 2A is provided with a position detection switch 12 for detecting the position of the dial member 9 along the direction perpendicular to the surface of the base 2A. In this configuration, when the dial member 9 is pushed along the direction perpendicular to the surface of the base 2A, the peripheral portion of the dial member 9 facing the position detection switch 12 presses the position detection switch 12, and thereby the position detection switch 12 is turned on, and when the dial member 9 is pulled back along the direction perpendicular to the surface of the base 2A, the position detection switch 12 is apart from the position detection switch 12, and thereby the position detection switch 12 is turned off.

The following is an explanation of the operation of the information display unit 100C having the above-mentioned configuration. First, the peripheral portion of the dial member 9 facing the position detection switch 12 is apart from the position detection switch 12 and therefore, the detection position switch 12 is assumed to be in the off position.

While the position detection switch 12 is in the off position, the control unit 7 displays the detailed map belonging to the lower level hierarchy on the display unit 5. When the dial member 9 is rotated in a state in which the peripheral portion of the dial member 9 facing the position detection switch 12 is apart from the position detection switch 12, the control unit 7, in accordance with the rotation of the dial member 9, moves the cursor on the detailed map displayed on the display unit 5, or scrolls the detailed map displayed on the display unit 5.

As a result of the dial member 9 being pushed along the direction perpendicular to the surface of the base 2A, when the dial member 9 presses the position detection switch 12 and thereby the position detection switch 12 is turned on, the hierarchy switching unit 11 switches the lower level hierarchy into the higher level hierarchy. The control unit 7 displays the wide-area map belonging to the higher level hierarchy switched by the hierarchy switching unit 11 on the display unit 5.

When the dial member 9 is rotated in a state in which the dial member 9 presses the position detection switch 12 and thereby the position detection switch 12 is turned on, the control unit 7, in accordance with the rotation of the dial member 9, moves the cursor on the wide-area map displayed on the display unit 5, or scrolls the wide-area map displayed on the display unit 5.

As a result of the dial member 9 being pulled back along the direction perpendicular to the surface of the base 2A, when the dial member 9 is apart from the position detection switch 12 and thereby the position detection switch 12 is turned off, the hierarchy switching unit 11 switches the higher level hierarchy into the lower level hierarchy. The control unit 7 displays the detailed map belonging to the lower level hierarchy switched by the hierarchy switching unit 11 on the display unit 5.

When the dial member 9 is rotated in a state in which the dial member 9 is apart from the position detection switch 12 and thereby the position detection switch is turned off, the control unit 7, in accordance with the rotation of the dial member 9, moves the cursor on the detailed map displayed on the display unit 5, or scrolls the detailed map displayed on the display unit 5.

Thus, the first scrolling operation of rotating the dial member 9 for scrolling the display unit 5 on which the detailed map belonging to the lower level hierarchy is displayed in a state in which the position detection switch 12 is in the off position, the second scrolling operation of rotating the dial member 9 for scrolling the display unit 5 on which the wide-area map belonging to the higher hierarchy is displayed in a state in which the position detection switch 12 is in the on position, and the hierarchy switching operation of pushing or pulling back the dial member 9 for switching the detailed map belonging to the lower level hierarchy and the wide-area map belonging to the higher level hierarchy to be displayed are the same kind of operation of moving the dial member 9. Thus, it is possible to display information including the intended destination from the hierarchical map information easily and rapidly.

(Second Embodiment)

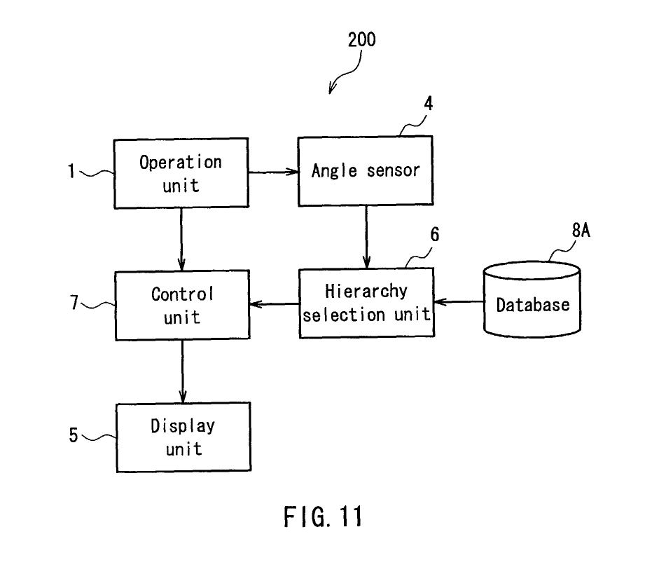

FIG. 11 is a block diagram showing an information display device 200 according to a second embodiment. The information display device 200 can display program information in an EPG. The same component elements as in the above-mentioned information display device 100 explained with reference to FIGS. 1 and 3 are given the same reference numerals and therefore the detailed explanation thereof is omitted herein. The difference from the above-mentioned information display device 100 is in that the database 8A is provided instead of the database 8.

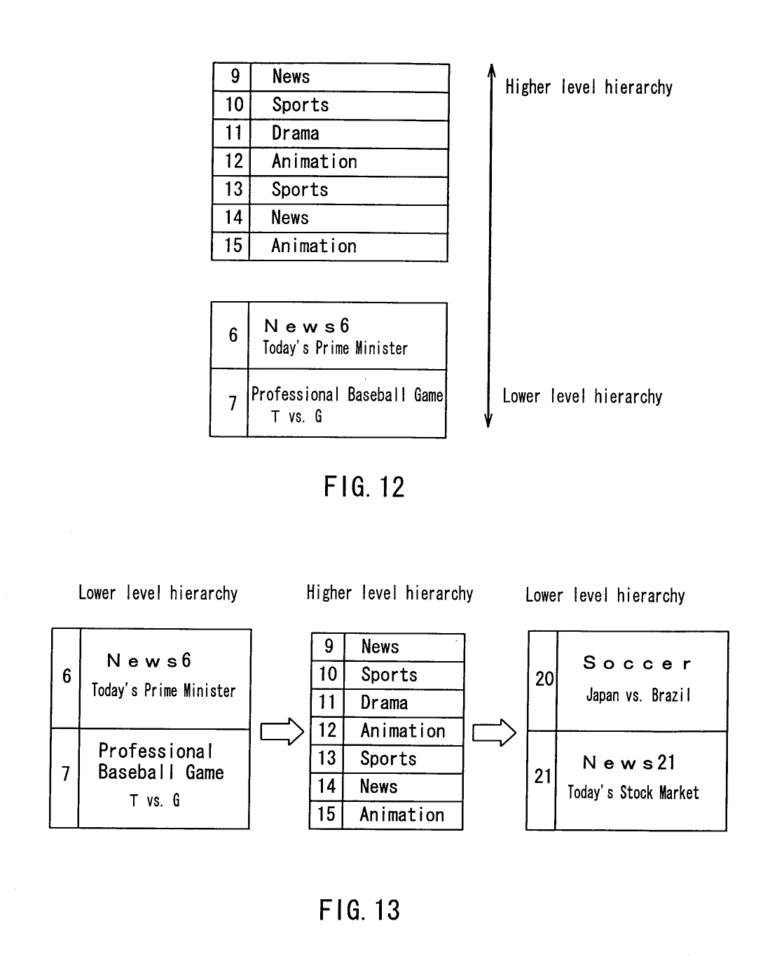

FIG. 12 is a view to illustrate program information in an EPG stored in the database 8A. The program information stored in the database 8A is hierarchized into a higher level hierarchy holding only information representing time period and genre and a lower level hierarchy holding time period, title, subtitle and contents, etc. of the program. Since the information held in the higher level hierarchy has a smaller amount of information for each program, a large number of programs can be displayed on a screen. Since the information held in the lower level hierarchy has a larger amount of information for each program, the detailed information can be displayed for each program. In an example shown in FIG. 12, for example, the information held in the lower level hierarchy shows that in the time period at 6:00, a program titled “News 6” is broadcasted and its subtitle is “Today's Prime Minister,” and in the time period at 7:00, a program titled “Professional Baseball Game” is broadcasted and its content is “T team vs. G team.” The information held in the higher level hierarchy includes only the time period and the genre, and for example, shows that in the time period at 9:00, a program belonging to the genre of “news” is broadcasted; in the time period at 10:00, a program belonging to the genre of “sports” is broadcasted; in the time period at 11:00, a program belonging to the genre of “drama” is broadcasted; in the time period at 12:00, a program belonging to the genre of “animation” is broadcasted; in the time period at 13:00, a program belonging to the genre of “sports” is broadcasted; in the time period at 14:00, a program belonging to the genre of “news” is broadcasted; and in the time period at 15:00, a program belonging to the genre of “animation” is broadcasted.

The following is an explanation of the operation of the information display unit 200 having the above-mentioned configuration. FIG. 13 is a view to illustrate program information in an EPG displayed on the display unit 5 provided in the information display device 200.

First, the stick 3 (FIG. 3) provided on the display unit 1 is assumed to be tilted at a tilt angle that is smaller than a predetermined tilt angle. The angle sensor 4 detects the tilt angle of the stick 3. The hierarchy selection unit 6 selects the program information belonging to the lower level hierarchy stored in the database 8A because the tilt angle detected by the angle sensor 4 is smaller than the predetermined tilt angle. The control unit 7 displays the program information belonging to the lower level hierarchy selected by the hierarchy selection unit 6. Thus, in the initial state, the program information belonging to the lower level hierarchy is displayed on the display unit 5. In an example shown in FIG. 13, the program information belonging to the lower level hierarchy, which is broadcasted in the time period at 6:00 and 7:00, is displayed on the display unit 5.

When the stick 3 is inclined forward/backward and right/left at the tilt angle that is smaller than the predetermined tilt angle, the control unit 7, in accordance with the inclining of the stick 3, moves the cursor vertically and horizontally on the program information belonging to the lower level hierarchy displayed on the display unit 5, or scrolls the program information belonging to the lower level hierarchy displayed on the display unit 5 vertically and horizontally.

In the case where a user wants to watch the time period at 20:00, which is distant from the time period displayed at present (6:00 and 7:00), if the user carries out scrolling with the program information belonging to the lower level hierarchy displayed, it takes a long time to reach the time period at 20:00 that the user wants to watch.

Therefore, in order to display the program information belonging to the higher level hierarchy, when the stick 3 is inclined in the direction across the direction expressed by the predetermined tilt angle from the tilt angle that is smaller than the predetermined tilt angle to the tilt angle that is not smaller than the predetermined tilt angle, the angle sensor 4 detects the tilt angle that is not smaller than the predetermined tilt angle as the tilt angle of the stick 3. Then, the hierarchy selection unit 6, which selected the program information belonging to the lower level hierarchy stored in the database 8A, selects the program information belonging to the higher level hierarchy because the tilt angle detected by the angle sensor 4 is not smaller than a predetermined tilt angle. Next, the control unit 7 displays the program information belonging to the higher level hierarchy selected by the hierarchy selection unit 6 on the display unit 5. Then, when the stick 3 is inclined forward/backward and right/left at the tilt angle that is not smaller than the predetermined tilt angle, the control unit 7, in accordance with the inclining of the stick 3, moves the cursor vertically and horizontally on the program information displayed on the display unit 5, or scrolls the program information displayed on the display unit 5 vertically and horizontally.

After a user moves the cursor onto the time period at 20:00 which the user wants to watch, when the stick 3 is inclined in the direction across the direction expressed by the predetermined tilt angle from the tilt angle that is not smaller than the predetermined tilt angle to the tilt angle that is smaller than the predetermined tilt angle, the angle sensor 4 detects the tilt angle that is smaller than the predetermined tilt angle as the tilt angle of the stick 3. Next, the hierarchy selection unit 6, which selected the program information belonging to the higher level hierarchy stored in the database 8, selects the program information belonging to the lower level hierarchy because the tilt angle detected by the angle sensor 4 is smaller than the predetermined tilt angle.

In an example shown in FIG. 13, for example, the program information belonging to the lower level hierarchy shows that in the time period at 20:00 which a user wants to watch, a program titled “Soccer” is broadcasted and its content is “Japan vs. Brazil.”

The control unit 7 displays the program information belonging to the lower level hierarchy selected by the hierarchy selection unit 6 on the display unit 5. Next, when the stick 3 is inclined forward/backward and right/left at the tilt angle that is smaller than the predetermined tilt angle, the control unit 7, in accordance with the inclining of the stick 3, moves the cursor on the program information belonging to the lower level hierarchy, or scrolls the program information belonging to the lower level hierarchy vertically and horizontally.

As mentioned above, according to the second embodiment, the information display device includes the display unit 5 capable of displaying the program information belonging to the lower level hierarchy and the program information belonging to the higher level hierarchy, and the operation unit 1 capable of executing a first scrolling operation for scrolling the display unit 5 on which the program information belonging to the lower level hierarchy is displayed, a second scrolling operation for scrolling the display unit 5 on which the program information belonging to the higher level hierarchy is displayed, and a hierarchy switching operation for switching between the program information belonging to the lower hierarchy and the program information belonging to the higher level hierarchy to be displayed. The first scrolling operation, the second scrolling operation and the hierarchy switching operation, which are executed by the operation unit 5, are the same operation of inclining the stick 3. Therefore, it is possible to display the target program information of a user to be displayed from the hierarchical program information easily and rapidly.

(Third Embodiment)

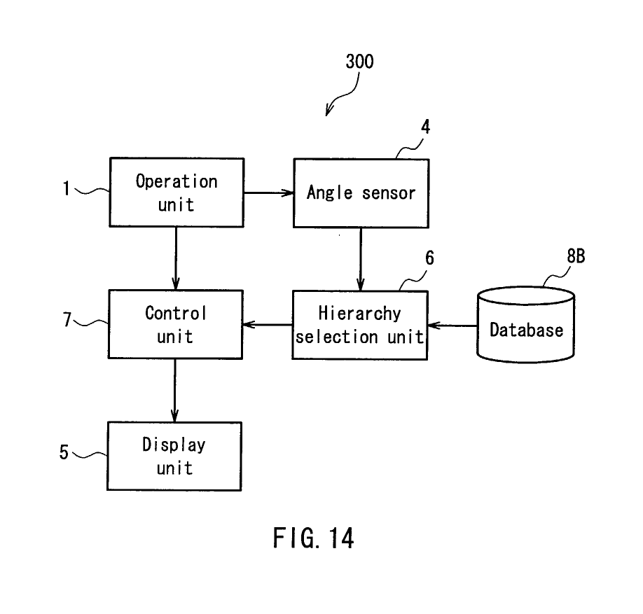

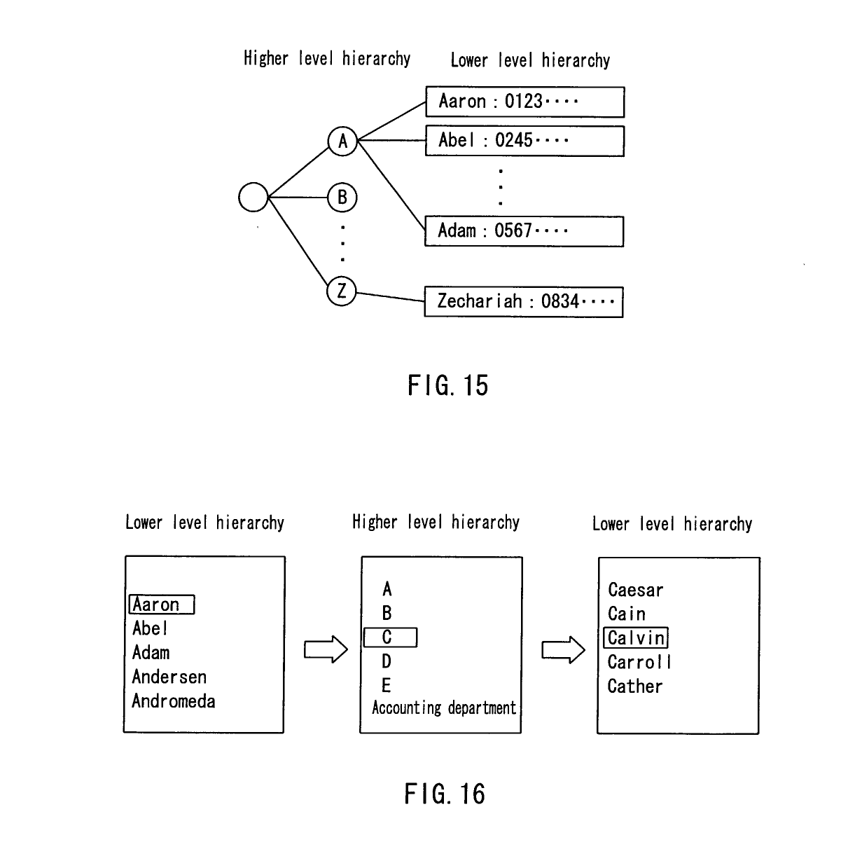

FIG. 14 is a block diagram showing an information display device 300 according to a third embodiment; and FIG. 15 is view to illustrate memory dial information stored in a database 8B provided in the information display device 300. The information display device 300 can display a number retrieving screen of a memory dial of a mobile telephone. The same component elements as in the above-mentioned information display device 100 described with reference to FIG. 1 are given the same reference numerals and therefore the detailed explanation thereof is omitted herein. The difference from the above-mentioned information display device 100 is in that the database 8B is provided instead of the database 8.

The memory dial information stored in the database 8B has a tree structure. The tree structure includes a lower level hierarchy showing detailed information such as a name or designation and a telephone number, etc. of an owner of telephone, and a higher level hierarchy showing the initial letter such as “A,” “B,”. . . , “Z” of the name or designation of the owner of telephone. In an example shown in FIG. 15, the memory dial information belonging to the higher level hierarchy including the initial letter of the name or designation of “A” corresponds to the memory dial information belonging to the lower level hierarchy including telephone numbers of, for example, “Aaron,” “Abel,”. . . , “Adam” whose initial letter of the name or designation is “A.” In the memory dial information belonging to the higher level hierarchy including the initial letter of the name or designation is “Z” corresponds to the memory dial information belonging to the lower level hierarchy including the telephone number of “Zechariah” whose initial letter of the name or designation is “Z.”

The following is an explanation of the operation of the information display unit 300 having the above-mentioned configuration. FIG. 16 is a view to illustrate memory dial information displayed on the display unit 5 provided in the information display device 300.

First, the stick 3 (FIG. 3) provided in the operation unit 1 is assumed to be tilted at an angle that is smaller than a predetermined tilt angle. The angle sensor 4 detects the tilt angle of the stick 3. The hierarchy selection unit 6 selects the memory dial information belonging to the lower level hierarchy stored in the database 8B because the tilt angle detected by the angle sensor 4 is smaller than the predetermined tilt angle. The control unit 7 displays the memory dial information belonging to the lower level hierarchy selected by the hierarchy selection unit 6 on a display unit 5. Thus, in the initial state, the memory dial information belonging to the lower level hierarchy is displayed on the display unit 5. In an example shown in FIG. 16, the memory dial information belonging to the lower level hierarchy showing “Aaron,” “Abel,” “Adam,” “Andersen” and “Andromeda” whose initial letter of the name or designation is “A” is displayed.

When the stick 3 is inclined at an angle that is smaller than the predetermined tilt angle, the control unit 7, in accordance with the inclining of the stick 3, moves the cursor on the memory dial information belonging to the lower level hierarchy displayed on the display unit 5, or scrolls the memory dial information belonging to the lower level hierarchy displayed on the display unit 5.

When the initial letter of the name or designation that a user wants to display is “C,” which is apart from “A” displayed at the present time, if scrolling is carried out with the memory dial information belonging to the lower level hierarchy displayed, it takes a long time to reach the initial letter “C” which the user wants to display.

Therefore, in order to display the memory dial information belonging to the higher level hierarchy, when the stick 3 is inclined in the direction across the direction expressed by the predetermined tilt angle from the tilt angle that is smaller than the predetermined tilt angle to the tilt angle that is not smaller than the predetermined tilt angle, the angle sensor 4 detects the tilt angle that is not smaller than the predetermined tilt angle as the tilt angle of the stick 3. Then, the hierarchy selection unit 6, which selected the memory dial information belonging to the lower level hierarchy stored in the database 8B, selects the memory dial information belonging to the higher level hierarchy because the tilt angle detected by the angle sensor 4 is not smaller than the predetermined tilt angle. Next, the control unit 7 displays the memory dial information belonging to the higher level hierarchy selected by the hierarchy selection unit 6 on the display unit 5. Thereafter, when the stick 3 is inclined at the tilt angle that is not smaller than the predetermined tilt angle, the control unit 7, in accordance with the inclining of the stick 3, moves the cursor on the memory dial information belonging to the higher level hierarchy displayed on the display unit 5, or scrolls the memory dial information belonging to the higher level hierarchy displayed on the display unit 5.

After the user moves the cursor onto “C,” that is, the initial letter of name or designation that the user wants to display, when the stick 3 is inclined in the direction across the direction expressed by the predetermined tilt angle from the tilt angle that is not smaller than the predetermined tilt angle to the tilt angle that is smaller than the predetermined tilt angle, the angle sensor 4 detects the tilt angle that is smaller than the predetermined tilt angle as the tilt angle of the stick 3. Next, the hierarchy selection unit 6, which selected the memory dial information belonging to the higher level hierarchy, selects the memory dial information belonging to the lower level information because the tilt angle detected by the angle sensor 4 is smaller than the predetermined tilt angle.

Thereafter, the control unit 7 displays the memory dial information belonging to the lower level hierarchy selected by the hierarchy selection unit 6 on the display unit 5. In an example shown in FIG. 16, in the memory dial information belonging to the lower level hierarchy, the initial letter of the name or designation is “C”, for example, “Caesar,” “Cain,” “Calvin,” “Carroll” and “Cather,” which the user wants to display, are displayed. When the stick 3 is inclined at a tilt angle that is smaller than the predetermined tilt angle, the control unit 7, in accordance with the inclining of the stick 3, moves the cursor on the memory dial information belonging to the lower level hierarchy displayed on the display unit 5, or scrolls the memory dial information belonging to the lower level hierarchy. FIG. 16 shows an example in which the cursor moves onto “Calvin.”

As mentioned above, according to the third embodiment, the information display device includes the display unit 5 capable of displaying memory dial information belonging to the lower level hierarchy and memory dial information belonging to the higher level hierarchy, and the operation unit 1 capable of executing a first scrolling operation for scrolling the display unit 5 on which the memory dial information belonging to the lower level hierarchy is displayed, a second scrolling operation for scrolling the display unit 5 on which the memory dial information belonging to the higher level hierarchy is displayed, and a hierarchy switching operation for switching between the memory dial information belonging to the lower level hierarchy and the memory dial information belonging to the higher level hierarchy to be displayed. The first scrolling operation, the second scrolling operation and the hierarchy switching operation, which are executed by the operation unit 5, are the same operation of inclining the stick 3. Therefore, it is possible to display the target memory dial information of a user from the hierarchical program information easily and rapidly.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. An information display device comprising:
a display capable of displaying at least first information belonging to a first hierarchy and second information belonging to a second hierarchy, and
an operation means capable of executing a first scrolling operation for scrolling the display on which the first information belonging to the first hierarchy is displayed, a second scrolling operation for scrolling the display on which the second information belonging to the second hierarchy is displayed, and a hierarchy switching operation for switching between the first information belonging to the first hierarchy and the second information belonging to the second hierarchy to be displayed; wherein
the first scrolling operation, the second scrolling operation and the hierarchy switching operation, which are executed by the operation means, are the same kind of operation.

2. The information display device according to claim 1, wherein the operation means comprises a base and a stick provided swingably on the base, and the same kind of operation is an operation of inclining the stick.

3. The information display device according to claim 2, wherein the first scrolling operation is an operation of inclining the stick at a tilt angle that is smaller than a predetermined tilt angle relative to the direction perpendicular to the base, the second scrolling operation is an operation of inclining the stick at a tilt angle that is not smaller than the predetermined tilt angle, and the hierarchy switching operation is an operation of inclining the stick in the direction across the direction expressed by the predetermined tilt angle.

4. The information display device according to claim 2, wherein the display displays the first information belonging to the first hierarchy while the tilt angle of the stick relative to the direction perpendicular to the base is smaller than the predetermined tilt angle, and displays the second information belonging to the second hierarchy while the tilt angle of the stick is not smaller than the predetermined tilt angle.

5. The information display device according to claim 2, further comprising:
an angle sensor for detecting the tilt angle of the stick relative to the direction perpendicular to the base, and
a hierarchy selection means for selecting any one of the first hierarchy and the second hierarchy based on the tilt angle of the stick detected by the angle sensor, wherein
the display displays the first information belonging to the first hierarchy while the hierarchy selection means selects the first hierarchy, and displays the second information belonging to the second hierarchy while the hierarchy selection means selects the second hierarchy.

6. The information display device according to claim 1, wherein the operation means comprises a base and a dial member provided rotatably on the base, and the same kind of the operation is an operation of rotating the dial member.

7. The information display device according to claim 6, wherein the first scrolling operation and the second scrolling operation are operations of rotating the dial member at a rotation speed that is lower than a predetermined rotation speed, and the hierarchy switching operation is an operation of rotating the dial member at a rotation speed that is not lower than the predetermined rotation speed.

8. The information display device according to claim 6, further comprising:
a rotation speed sensor for detecting the rotation speed of the dial member, and
a hierarchy switching means for switching between the first hierarchy and the second hierarchy based on the rotation speed of the dial member detected by the rotation speed sensor, wherein
the display switches between the first information belonging to the first hierarchy and the second information belonging to the second hierarchy to be displaced, in accordance with the switching between the first hierarchy and the second hierarchy by the hierarchy switching means.

9. The information display device according to claim 1, wherein the operation means comprises a base and a stick provided swingably on the base, and the same kind of operation is an operation of moving the stick.

10. The information display device according to claim 9, wherein the first scrolling operation and the second scrolling operation are operations of inclining the stick, and the hierarchy switching operation is an operation of moving the stick along the axis direction of the stick.

11. The information display device according to claim 9, wherein the hierarchy switching operation is an operation of pushing the stick into the base along the axis direction of the stick.

12. The information display device according to claim 9, wherein the hierarchy switching operation is an operation of pulling back the stick from the base along the axis direction of the stick.

13. The information display device according to claim 9, further comprising a position detection means for detecting the position along the axis direction of the stick, and a hierarchy selection means for selecting any one of the first hierarchy and the second hierarchy based on the position along the axis direction of the stick detected by the position detection means, wherein
the display displays the first information belonging to the first hierarchy while the hierarchy selection means selects the first hierarchy, and displays the second information belonging to the second hierarchy while the hierarchy selection means selects the second hierarchy.

14. The information display device according to claim 1, wherein the operation means comprises a base and a dial member provided rotatably on the base, and the same kind of operation is an operation for moving the dial member.

15. The information display device according to claim 14, wherein the first scrolling operation and the second scrolling operation are operations of rotating the dial member, and the hierarchy switching operation is an operation of moving the dial member along the direction perpendicular to the rotation axis of the dial member.

16. The information display device according to claim 14, wherein the hierarchy switching operation is an operation for pushing the dial member into the base along the direction perpendicular to the rotation axis of the dial member.

17. The information display device according to claim 14, wherein the hierarchy switching operation is an operation for pulling back the dial member from the base along the direction perpendicular to the rotation axis of the dial member.

18. The information display device according to claim 14, further comprising a position detection means for detecting the position along the direction perpendicular to the rotation axis of the dial member, and a hierarchy selection means for selecting any of the first hierarchy and the second hierarchy based on the position along the direction perpendicular to the rotation axis of the dial member detected by the position detection means, wherein
the display displays the first information belonging to the first hierarchy while the hierarchy selection means selects the first hierarchy, and displays the second information belonging to the second hierarchy while the hierarchy selection means selects the second hierarchy.

19. The information display device according to claim 1, wherein the second information belonging to the second hierarchy is information of broader concept with respect to the first information belonging to the first hierarchy.

20. The information display device according to claim 1, wherein the first information belonging to the first hierarchy and the second information belonging to the second hierarchy are information representing a map.

21. The information display device according to claim 1, wherein the first information belonging to the first hierarchy is information representing a detailed map, and the second information belonging to the second hierarchy is information representing a wide-area map.

22. The information display device according to claim 1, wherein the first information belonging to the first hierarchy and the second information belonging to the second hierarchy are program information in an Electronic Program Guide.

23. The information display device according to claim 1, wherein the first information belonging to the first hierarchy and the second information belonging to the second hierarchy are information relating to a phone memory dial.

24. A method for displaying information, the method comprising
displaying at least a first information belonging to a first hierarchy on the display,
executing a first scrolling operation for scrolling the display on which the first information belonging to the first hierarchy is displayed,
executing a hierarchy switching operation for switching the first information belonging to the first hierarchy to a second information belonging to a second hierarchy to be displayed on the display, and
executing a second scrolling operation for scrolling the display on which the second information belonging to the second hierarchy is displayed, wherein
the first scrolling operation, the second scrolling operation and the hierarchy switching operation are the same kind of operation.
